(19) United States
(12) Patent Application Publication
(10) Pub. No.: US 2011/0226724 A1
(43) Pub. Date: Sep. 22, 2011

(54) RADIATION CURED ADHESIVES FOR ATTACHING FUNCTIONAL AND/OR DECORATIVE ITEMS TO PLASTIC CONTAINERS

(76) Inventors: DAVID A. DEEMER, Adrian, MI (US); Susan Deemer, Adrian, MI (US); Brad Wilson, Manchester, MI (US); Frederick C. Beuerle, Jackson, MI (US); Luke A. Mast, Brooklyn, MI (US); Michael T. Lane, Brooklyn, MI (US)

(21) Appl. No.: 13/048,948

(22) Filed: Mar. 16, 2011

Related U.S. Application Data
(60) Provisional application No. 61/314,301, filed on Mar. 16, 2010.

(51) Int. Cl. B65D 23/10; B29C 65/14

(52) U.S. Cl. 215/398; 156/275.5

(57) ABSTRACT

A handled container and method of manufacturing the same using radiation energy, such as ultraviolet light, visible light, electron beam and the like, to cure a corresponding adhesive for attaching plastic handles or other functional and/or decorative items to plastic containers. The container of the present teachings, unlike conventional containers, provided an improved and reliable handle arrangement, thereby permitting more complex handle shapes without substantially effecting manufacturing costs and complexity.

### CROSS-REFERENCE TO RELATED APPLICATIONS

This application claims the benefit of U.S. Provisional Application No. 61/314,301, filed on Mar. 16, 2010. The entire disclosure of the above application is incorporated herein by reference.

### FIELD

This disclosure generally relates to containers for retaining a commodity, such as a solid or liquid commodity. More specifically, this disclosure relates to a blown polyethylene terephthalate (PET) container having a handle or alternate item attached thereto using a radiation-curable adhesive.

### BACKGROUND

This section provides background information related to the present disclosure which is not necessarily prior art.

As a result of environmental and other concerns, plastic containers, more specifically polyester and even more specifically polyethylene terephthalate (PET) containers are now being used more than ever to package numerous commodities previously supplied in glass containers. Manufacturers and fillers, as well as consumers, have recognized that PET containers are lightweight, inexpensive, recyclable and manufacturable in large quantities.

Blow-molded plastic containers have become commonplace in packaging numerous commodities. PET is a crystallizable polymer, meaning that it is available in an amorphous form or a semi-crystalline form. The ability of a PET container to maintain its material integrity relates to the percentage of the PET container in crystalline form, also known as the “crystallinity” of the PET container. The following equation defines the percentage of crystallinity as a volume fraction:

$$\% Crystallinity = ( \frac{ρ - {ρ}_{a}}{{ρ}_{c} - {ρ}_{a}} ) \times 100$$

where ρ is the density of the PET material; ρₐ is the density of pure amorphous PET material (1.333 g/cc); and ρ_{c} is the density of pure crystalline material (1.455 g/cc).

Container manufacturers use mechanical processing and thermal processing to increase the PET polymer crystallinity of a container. Mechanical processing involves orienting the amorphous material to achieve strain hardening. This processing commonly involves stretching an injection molded PET preform along a longitudinal axis and expanding the PET preform along a transverse or radial axis to form a PET container. The combination promotes what manufacturers define as biaxial orientation of the molecular structure in the container. Manufacturers of PET containers currently use mechanical processing to produce PET containers having approximately 20% crystallinity in the container's sidewall.

Thermal processing involves heating the material (either amorphous or semi-crystalline) to promote crystal growth. On amorphous material, thermal processing of PET material results in a spherulitic morphology that interferes with the transmission of light. In other words, the resulting crystalline material is opaque, and thus, generally undesirable. Used after mechanical processing, however, thermal processing results in higher crystallinity and excellent clarity for those portions of the container having biaxial molecular orientation. The thermal processing of an oriented PET container, which is known as heat setting, typically includes blow molding a PET preform against a mold heated to a temperature of approximately 250° F.-350° F. (approximately 121° C.-177° C.), and holding the blown container against the heated mold for approximately two (2) to five (5) seconds. Manufacturers of PET juice bottles, which must be hot-filled at approximately 185° F. (85° C.), currently use heat setting to produce PET bottles having an overall crystallinity in the range of approximately 25%-35%.

Traditionally, handles on plastic bottles are created either by pinching off the material during blowing to form an integral hollow handle or by attaching a previously molded handle to the bottle during blowing or immediately after blowing the container. As can be appreciated, attachment of the previously molded handle during the blowing or immediately after blowing the container can require extensive and expensive machinery at or near the blowing station. Such requirement can lead to increased costs and complexity during the blowing process.

Typically, the pre-molded handles are attached either by encapsulating lugs on the handle within the blown material or by wrapping a portion of the handle around a part of the container. The hollow handle approach is not possible with all types of plastic materials (most notably PET) and the re-molded handle option results in significant blowing process limitations, significantly more material and a generally weak handle attachment. Both methods severely limit container, handle and blow mold design options.

### SUMMARY

This section provides a general summary of the disclosure, and is not a comprehensive disclosure of its full scope or all of its features.

According to the principles of the present disclosure, a handled container and method of manufacturing the same is provided that uses radiation energy, such as ultraviolet light, visible light, electron beam and the like, to cure a corresponding adhesive for attaching rigid, or semi rigid, plastic handles or other functional and/or decorative items to plastic containers. The container of the present teachings, unlike conventional containers, provided an improved and reliable handle arrangement, thereby permitting more complex handle shapes without substantially effecting manufacturing costs and complexity.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a side view of a plastic container constructed in accordance with the teachings of the present disclosure;

FIGS. 2A-2D is a series of side views of a plastic container according to some embodiments of the present teachings;

FIGS. 3A-3C is a series of side views of a plastic container according to some embodiments of the present teachings;

FIGS. 4A-4C is a series of side views of a plastic container according to some embodiments of the present teachings;

FIGS. 5A-5C is a series of side views of a plastic container according to some embodiments of the present teachings;

FIGS. 6A-6B is a series of side views of a plastic container according to some embodiments of the present teachings;

FIG. 7 is a side view of a plastic container according to some embodiments of the present teachings with an angled handle assembly;

FIG. 8 is a side view of a plastic container according to some embodiments of the present teachings with a handle assembly generally aligned with an axis of the plastic container;

FIG. 9 is a side view of a handle assembly coupled to a container;

FIG. 10 is a front view of the handle assembly of FIG. 9;

FIG. 11 is a side view of a handle assembly coupled to a container;

FIG. 12 is a front view of the handle assembly of FIG. 11;

FIG. 13 is a schematic view of a manufacturing system for forming a container, attaching a handle assembly, and curing an associated adhesive according to the principles of the present teachings.

Corresponding reference numerals indicate corresponding parts throughout the several views of the drawings.

### DETAILED DESCRIPTION

Example embodiments will now be described more fully with reference to the accompanying drawings. Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure.

The terminology used herein is for the purpose of describing particular example embodiments only and is not intended to be limiting. As used herein, the singular forms “a”, “an” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on”, “engaged to”, “connected to” or “coupled to” another element or layer, it may be directly on, engaged, connected or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The present teachings provide a handled container and method of manufacturing the same using radiation energy, such as ultraviolet light, visible light, electron beam and the like, to cure a corresponding adhesive for attaching rigid plastic handles or other functional and/or decorative items to plastic containers. The container of the present teachings, unlike conventional containers, provided an improved and reliable handle arrangement, thereby permitting more complex handle shapes without substantially effecting manufacturing costs and complexity.

As will be discussed in greater detail herein, the shape of the container of the present teachings can be formed according to any one of a number of variations. By way of non-limiting example, the container of the present disclosure can be configured to hold any one of a plurality of commodities, such as beverages, food, or other hot-fill type materials.

It should be appreciated that the size and the exact shape of the container and handle are dependent on the size of the container and the required design criteria. Therefore, it should be recognized that variations can exist in the presently described designs. According to some embodiments, it should also be recognized that the container can include additional features, such as vacuum absorbing features or regions in the form of panels, ribs, slots, depressions, and the like.

Although the present teachings are discussed in connection with the attachment of a handle or handle assembly, it should be recognized that the present teachings are not limited thereto. These teachings can be used to attach any one of a number of items, members, or components to a container. By way of non-limiting example, the present teachings can be used to attach a second container to a first container (such, but not limited to, as a container for holding eye contact lenses with a separate container for the solution) and/or attach a dispensing cup, spoon, or other utensil, a carrying implement (such as a “dog-bone” or other member, latch, hook, or related structure), a toy or decorative article, or any other article. It should also be recognized that the handle can be configured in any one of a number of configurations, including a unitarily-formed handle, a multi-piece handle, or the like. It should be recognized that the terms handle, handle assembly, and/or handle member may be used interchangeably to denote any or all handle configurations. Finally, it should be understood that the attached member, whether it is a handle or any of the aforementioned articles, can be made from materials other than plastic or plastic components, so long as the material used is compatible with the radiation cured adhesive.

As illustrated throughout the several figures, the present teachings provide a one-piece plastic, e.g. polyethylene terephthalate (PET), container generally indicated at 10. The container 10 comprises an integrated handle design according to the principles of the present teachings. Those of ordinary skill in the art would appreciate that the following teachings of the present disclosure are applicable to other containers, such as rectangular, triangular, hexagonal, octagonal or square shaped containers, which may have different dimensions and volume capacities. It is also contemplated that other modifications can be made depending on the specific application and environmental requirements.

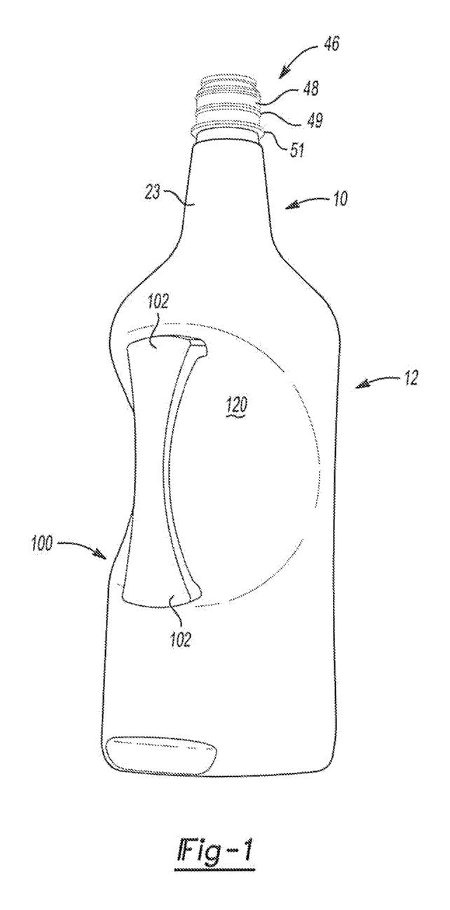

As shown in FIGS. 1-8, in some embodiments, the one-piece plastic container 10 can define a body 12, and includes an upper portion 14 having a cylindrical sidewall 18 forming a finish 20. Integrally formed with the finish 20 and extending downward therefrom is a shoulder portion 22. The shoulder portion 22 merges into and provides a transition between the finish 20 and a sidewall portion 24. The sidewall portion 24 extends downward from the shoulder portion 22 to a base portion 28 having a base 30. An upper transition portion 32, in some embodiments, may be defined at a transition between the shoulder portion 22 and the sidewall portion 24. A lower transition portion 34, in some embodiments, may be defined at a transition between the base portion 28 and the sidewall portion 24.

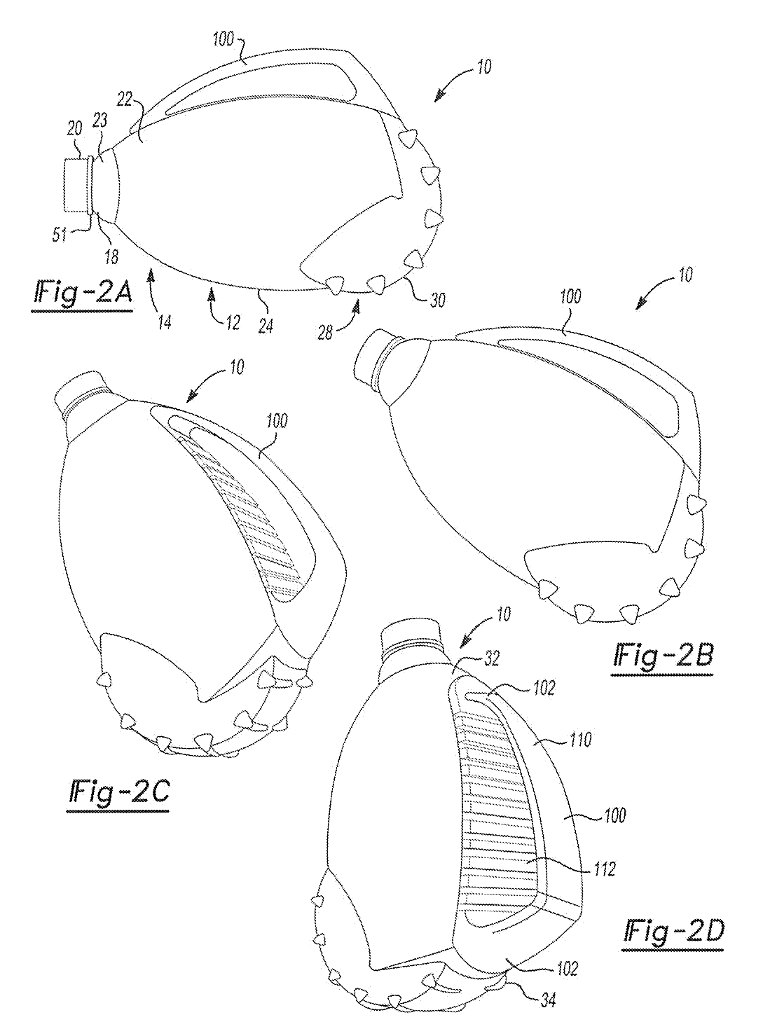

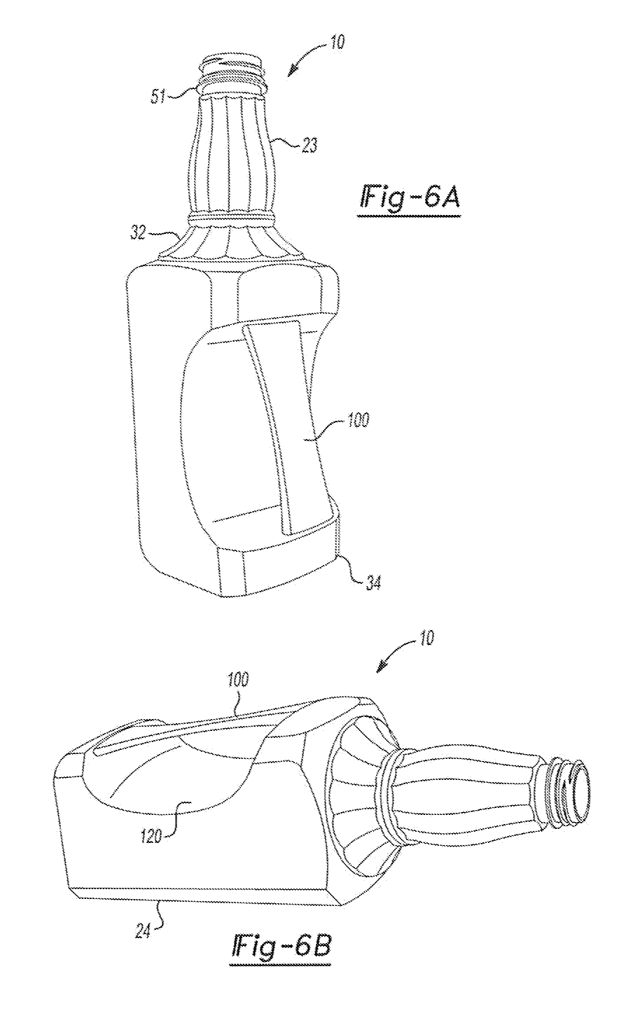

The exemplary container 10 may also have a neck 23. The neck 23 may have an extremely short height (FIGS. 2-5), that is, becoming a short extension from the finish 20, or an elongated height (FIGS. 1 and 6), extending between the finish 20 and the shoulder portion 22. The upper portion 14 can define an opening. Although the container is shown as a drinking container, it should be appreciated that containers having different shapes, such as sidewalls and openings, can be made according to the principles of the present teachings for various uses, such as food or chemical storage.

As illustrated in FIGS. 1-8, the finish 20 of the plastic container 10 may include a threaded region 46 having threads 48, a lower sealing ridge 49, and a support ring 51. The threaded region 46 provides a means for attachment of a similarly threaded closure or cap. Alternatives may include other suitable devices that engage the finish 20 of the plastic container 10, such as a press-fit or snap-fit cap for example. Accordingly, the closure or cap engages the finish 20 to preferably provide a hermetical seal of the plastic container 10. The closure or cap is preferably of a plastic or metal material conventional to the closure industry and suitable for subsequent thermal processing.

Still referring to FIGS. 1-8, the present teachings further comprise a handle assembly 100 being separately formed from container 10, yet connectable thereto. Handle assembly 100 can comprise any one of a number of shapes, contours, structures, and the like. Moreover, it should be appreciated that handle assembly 100 can define a first shape, contour, structure, or the like that can be used on a plurality of container shapes, contours, or structures, thereby providing improved manufacturing efficiencies. Likewise, it should be appreciated that a single container shape, contour, or structure can be coupled with any one of a plurality of handle assembly shapes, contours, or structures to provide an increased number of container permutations.

Handle assembly 100 can define any one of a number of surface textures that facilitate handling or grasping of container 10. Moreover, such surface textures can be used to enhance or maximize the contact surface area between handle assembly 100 and container 10 to produce an improved bonding interface.

It should also be appreciated that attachment of handle assembly 100 to container 10 can provide improved structural integrity to the combined container assembly, thereby permitting lighter materials to be used in handle assembly 100 and container 10. Such arrangement can reduce shipping weights, and associated materials and transportation costs.

With reference to FIG. 1, it can be seen that handle assembly 100 can comprise an elongated and centrally narrow handle member having opposing coupling ends 102. Coupling ends 102 can be joined or otherwise bonded to container 10, as will be discussed in detail herein. Similarly, with reference to FIG. 2, handle assembly 100 can comprise an integrated handle 110 and base plate 112 that are joined or otherwise integrally formed as a single handle member. Base plate 112 can be shaped to complement a corresponding sidewall or shoulder portion of container 10. Moreover, base plate 112 can be shaped to complement a depression formed in container 10 for receiving base plate 112.

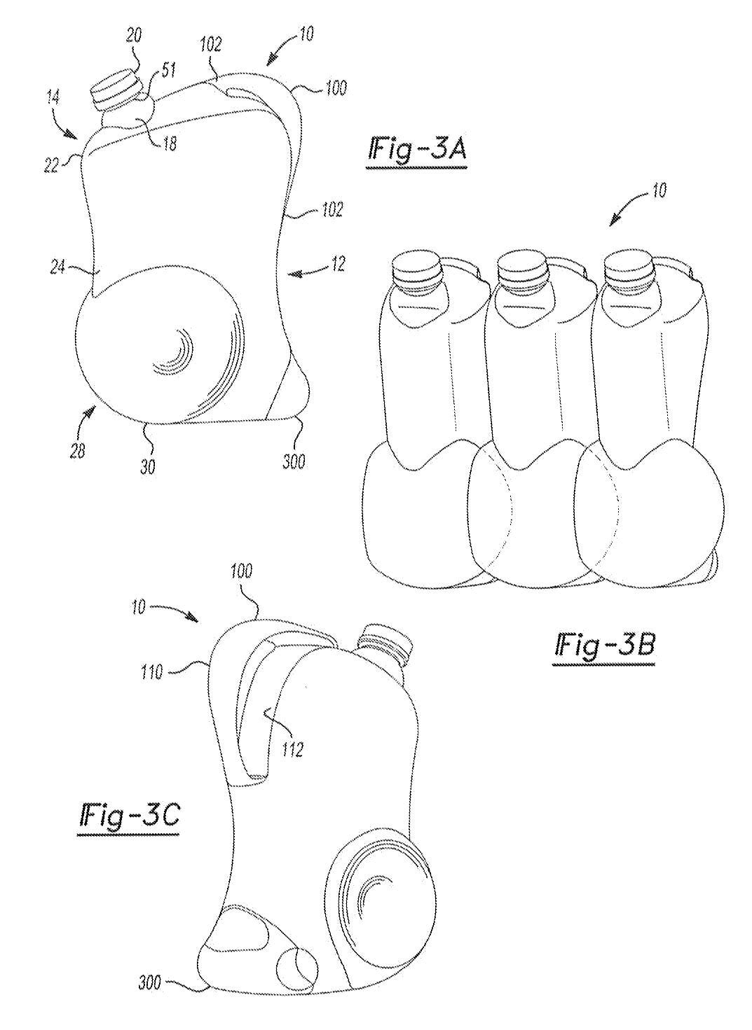

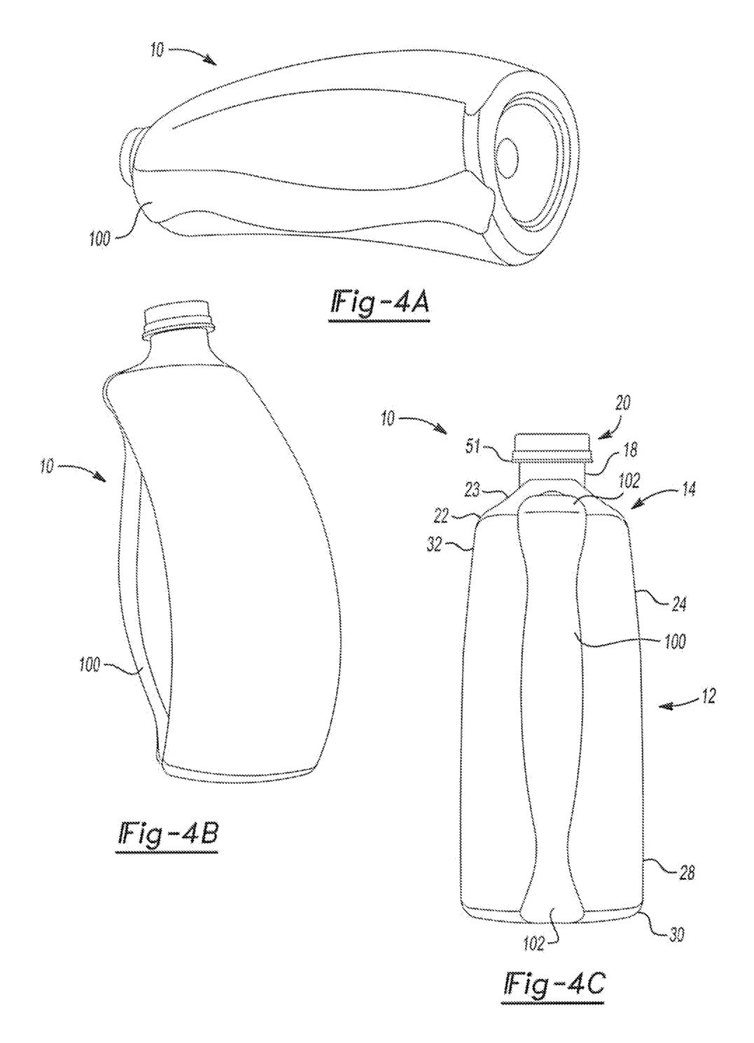

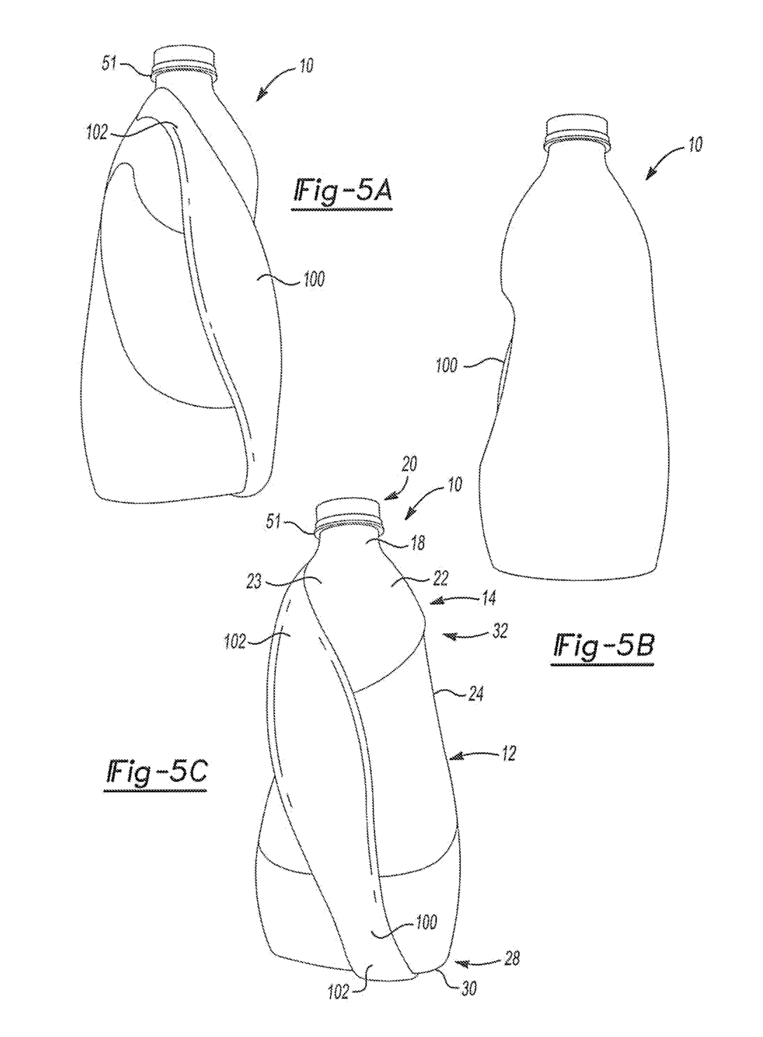

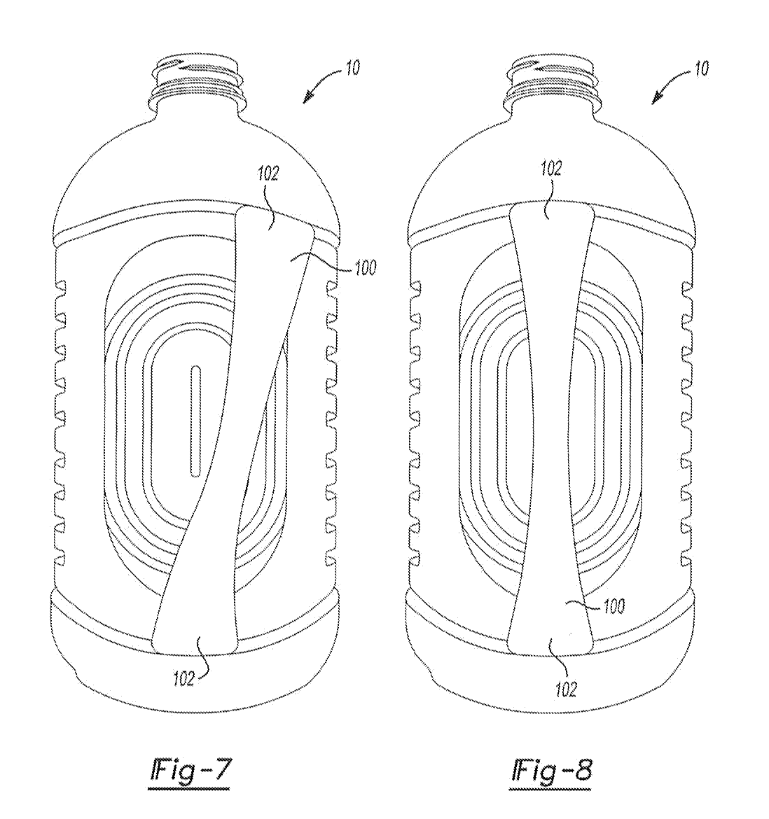

Referring now to FIGS. 3A-3C, similar to FIGS. 2A-2D, handle assembly 100 can comprise an integrated handle 110 and base plate 112. Moreover, container 10 can comprise an add-on member 300 that, in this embodiment comprises a base structure that is joined to container 10 in a manner similar to handle assembly 100. It should be appreciated, as seen in FIGS. 4A-5C, that handle assembly 100 can extend from an upper section, such as the shoulder portion 22, to a lower section, such as the base portion 28. Moreover, handle assembly 100 can be generally aligned with a longitudinal axis of the container (FIGS. 4A-4C and 8) or can be disposed at an angle thereto (FIGS. 5A-5C and 7). Still further, in some embodiments, handle assembly 100 can be disposed and coupled within a hand void 120 formed in sidewall portion 24 of container 10. In such an embodiment, the outer shape and/or perimeter of container 10 and handle assembly 100 can be maintained compared to existing containers, thereby minimizing its effect on packaging, storage, transport, and product display.

As discussed herein, handle assembly 100 and/or add-on member 300 (collectively referred to as handle assembly 100 herein) can be coupled to container 10 using radiation energy, such as ultraviolet light, visible light, electron beam and the like, to cure a corresponding adhesive used to join handle assembly 100 to container 10. The container of the present teachings, unlike conventional containers, provided an improved and reliable handle arrangement, thereby permitting more complex handle shapes without substantially effecting manufacturing costs and complexity. Moreover, in some embodiments, the use of electron beam can be used to accommodate or otherwise create opaque portions on handle assembly 100.

Handle assembly 100 can be made of any material conducive to a particular application. By way of non-limiting example, handle assembly 100 can be made of a foamed PET or a non-food grade PCR (at any percentage up to 100%). Moreover, handle assembly 100 can include various fillers, additives, and/or colorants as desired.

In some embodiments, the preferred adhesives can be solvent free, which eliminates potential solvent migration problems into consumable products inside of container 10s. The bond provided by these adhesives is very strong and not subject to weakening or failure due to temperature extremes within the normal use temperatures of these containers, which can occur with traditional solvent based or hot melt adhesives. Radiation cured adhesives can be cured in as little as one second and can also provide the ability to quickly tack handle assembly 100 to container 10 in a handle application machine, thereby eliminating the need to maintain a constant holding force on handle assembly 100 until all of the adhesive in the joint is fully cured. This can permit container 10 to be moved to a downstream location for a full curing operation relative to handle assembly 100 applicator location. This results in a smaller, more efficient, handle application machine. It should be recognized that radiation cured adhesives require substantially less energy then hot melt adhesives or other forms of attachment like ultrasonic or friction welding.

This type of adhesive allows for normal use temperatures between −40 and +275 degrees F. The use of an adhesive to attach handles removes container design limitations and allows handles to span recessed pockets in the container sidewall without needing to have that pocket extend from one side of the bottle to the other in order to avoid undercuts in the blow mold. This results in smaller, more compact containers. The ability to glue on a handle assembly 100 also decouples the handle attachment process from the blow molding process and allows the blowing machine to run at optimum speeds. Because of the simple surface to surface attachment method there is less material required in handle assembly 100 and even container 10 can be lighter weight because the blow material doesn't need to wrap around lugs on handle assembly 100 or resist bucking if handle assembly 100 is wrapped around container 10.

Because radiation cured adhesives, in some embodiments, are cross linked polymers that will not melt during subsequent reprocessing of the bonded materials, it is possible to remove the cross linked adhesives from recycled material with standard melt filtering technology. Traditional solvent based and hot melt adhesives are much more likely to contaminate the recycling stream.

The availability of colored radiation cured adhesives that become clear when they are cured makes it easy to verify that the adhesive has been properly applied and cured. Generally the curing of these adhesives is dependent on getting UV or visible light into the glue joint, if this is not possible, for example because of an opaque handle and bottle, electron beams can also be used to cure the adhesive. Electron Beam Radiation (EBR) could also be used to simultaneously sterilize container 10.

While not necessary for adequate bond strength, the use of embossed and/or debossed features on container 10 and/or handle assembly 100 can provide an increased joint surface area and controlled adhesive containment resulting in stronger joints with less adhesive. It should be recognized that embossed and/or debossed features, or other mechanical attachment methods, can be used to couple at least one end of handle assembly 100 to container 10. Moreover, such mechanical attachment methods can be used at one end in place of the aforementioned adhesive material.

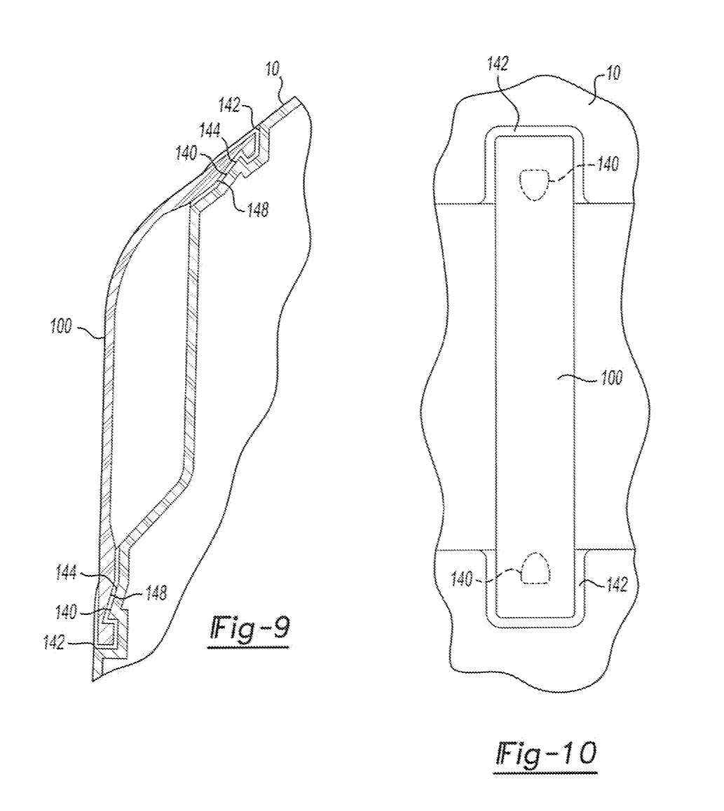

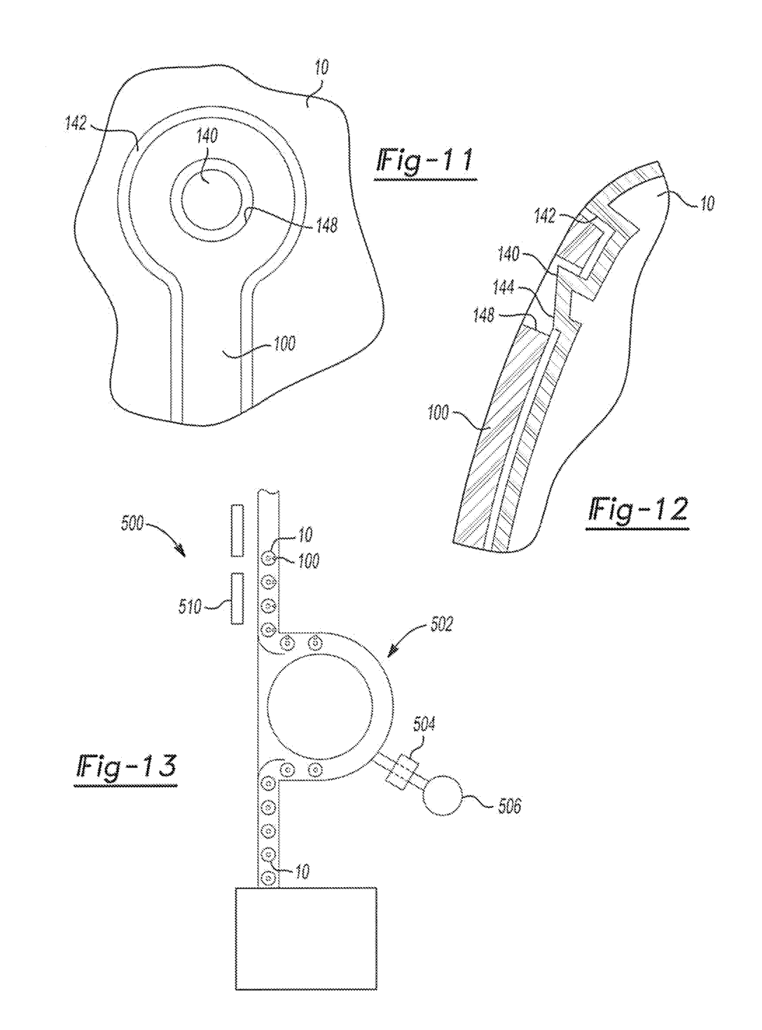

Specifically, as seen in FIGS. 9-12, container 10 can comprise an embossed feature 140 extending outward from an adjacent surface, such as a debossed area 142, shoulder portion 22, sidewall portion 24, and/or base portion 28. In some embodiments, embossed feature 140 can comprise a sloped face 144 (FIGS. 9 and 12) to facilitate installation of handle assembly 100. Embossed feature 140 can be sized and shaped to couple with a depression, through-hole, or other feature 148 formed in handle assembly 100 to form at least a temporary bond with embossed feature 140 of container 10. These features can also be used to help temporarily hold container 10 and handle assembly 100 together, further simplifying handle application machine and allowing additional time to fully cure the adhesive. Debossed area 142 can be used to provide lateral support of handle assembly 100 within a designated area and/or provide a smooth and edge free surface contour along container 10 when handle assembly 100 is installed.

In addition to rigid injection molded handles, gas assisted injection molding could be used to provide the appearance of hollow handles or thermoforming could be used to produce very light weight foldable handles. Handle assembly 100 can also be manufactured using a dual shot, a multilayer, a gas-assist, and/or a material foaming molding system. Stamped handles as those used for carrying a bottle by the neck ring, can also be attached to the container using this adhesive, or a combination of the current method around the neck portion and the adhesive to a lower portion.

This combination of flexibility, material savings, energy savings and recyclability results in a very environmentally responsible package.

Generally, plastic container 10 has been designed to retain a commodity. The commodity may be in any form such as a solid or semi-solid product. In one example, a commodity may be introduced into the container during a thermal process, typically a hot-fill process. For hot-fill bottling applications, bottlers generally fill the container 10 with a product at an elevated temperature between approximately 155° F. to 205° F. (approximately 68° C. to 96° C.) and seal the container 10 with a closure (not illustrated) before cooling. In addition, the plastic container 10 may be suitable for other high-temperature pasteurization or retort filling processes or other thermal processes as well. In another example, the commodity may be introduced into the container under ambient temperatures.

The plastic container 10, separate from handle assembly 100, of the present disclosure is a blow molded, biaxially oriented container with a unitary construction from a single or multi-layer material. A well-known stretch-molding, heat-setting process for making the one-piece plastic container 10 can be used that generally involves the manufacture of a preform (not shown) of a polyester material, such as polyethylene terephthalate (PET), having a shape well known to those skilled in the art similar to a test-tube with a generally cylindrical cross section. An exemplary method of manufacturing the plastic container 10 will be described in greater detail later.

An exemplary method of forming the container 10 will be described. A preform version of container 10 includes a support ring 51, which may be used to carry or orient the preform through and at various stages of manufacture. For example, the preform may be carried by the support ring 51, the support ring 51 may be used to aid in positioning the preform in a mold cavity, or the support ring 51 may be used to carry an intermediate container once molded. At the outset, the preform may be placed into the mold cavity such that the support ring 51 is captured at an upper end of the mold cavity. In general, the mold cavity has an interior surface corresponding to a desired outer profile of the blown container. More specifically, the mold cavity according to the present teachings defines a body forming region, an optional moil forming region and an optional opening forming region. Once the resultant structure, hereinafter referred to as an intermediate container, has been formed, any moil created by the moil forming region may be severed and discarded. It should be appreciated that the use of a moil forming region and/or opening forming region are not necessarily in all forming methods.

In one example, a machine (not illustrated) places the preform heated to a temperature between approximately 190° F. to 250° F. (approximately 88° C. to 121° C.) into the mold cavity. The mold cavity may be heated to a temperature between approximately 250° F. to 350° F. (approximately 121° C. to 177° C.). A stretch rod apparatus (not illustrated) stretches or extends the heated preform within the mold cavity to a length approximately that of the intermediate container thereby molecularly orienting the polyester material in an axial direction generally corresponding with the central longitudinal axis of the container 10. While the stretch rod extends the preform, air having a pressure between 300 PSI to 600 PSI (2.07 MPa to 4.14 MPa) assists in extending the preform in the axial direction and in expanding the preform in a circumferential or hoop direction thereby substantially conforming the polyester material to the shape of the mold cavity and further molecularly orienting the polyester material in a direction generally perpendicular to the axial direction, thus establishing the biaxial molecular orientation of the polyester material in most of the intermediate container. The pressurized air holds the mostly biaxial molecularly oriented polyester material against the mold cavity for a period of approximately two (2) to five (5) seconds before removal of the intermediate container from the mold cavity. This process is known as heat setting and results in a heat-resistant container suitable for filling with a product at high temperatures.

Alternatively, other manufacturing methods, such as for example, extrusion blow molding, one step injection stretch blow molding and injection blow molding, using other conventional materials including, for example, high density polyethylene, polypropylene, polyethylene naphthalate (PEN), a PET/PEN blend or copolymer, and various multilayer structures may be suitable for the manufacture of plastic container 10. Those having ordinary skill in the art will readily know and understand plastic container manufacturing method alternatives.

Once container 10 is formed, handle assembly 100 can be attached thereto. In some embodiments, handle assembly 100 can be coupled to container 10 such that depression feature 148 of handle assembly 100 is coupled to embossed feature 140 of container 10 to at least temporarily retain handle assembly 100 to container 10 before, during, and/or after curing of the adhesive. Adhesive can be applied to at least a portion of handle assembly 100 that contacts container 10 (such as at embossed feature 140 and/or debossed area 142) or directly to container 10. The adhesive can then be activated using radiation energy, such as from an ultraviolet source, visible light source, or other related source, to affect a bond between handle assembly 100 and container 10. Specifically, as seen in FIG. 13, container 10 can exit a blow molder and travel along a conveyor line 500 to a handle applicator system 502. Handle applicator system 502 can be a rotary or linear design depending on the desired system speed. Handle applicator system 502 can include an adhesive applicator 504 for applying adhesive to handle assembly 100 transported from a handle unscrambler 506. The handle assembly 100, now having adhesive disposed thereon, can be affixed to container 10. Finally, at a downstream location, if desired, radiation panels 510 can be used to apply radiation energy to the adhesive to finalize and/or cure the adhesive, thereby reliably joining handle assembly 100 to container 10.

The foregoing description of the embodiments has been provided for purposes of illustration and description. It is not intended to be exhaustive or to limit the invention. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the invention, and all such modifications are intended to be included within the scope of the invention.

What is claimed is:

1. A blow-molded plastic container comprising:
a container body;
a handle member; and
an adhesive disposed between the container body and the handle member, the adhesive being radiation cured.

2. The blow-molded plastic container of claim 1, further comprising:
an embossed feature formed on at least one of the container body and the handle member; and
a corresponding feature formed on the other of the container body and the handle member, the corresponding feature engaging the embossed feature.

3. The blow-molded plastic container of claim 1 wherein the container body comprises a recessed portion for receiving the handle member.

4. The blow-molded plastic container of claim 1 wherein the adhesive is cured using at least one of ultraviolet light, visible light, and electron beam.

5. The blow-molded plastic container of claim 1 wherein the container body is made of a first material and the handle member is made of a second material, the first material and the second material being different.

6. The blow-molded plastic container of claim 1 wherein the container body is made of a first material and the handle member is made of a second material, the first material and the second material being the same.

7. The blow-molded plastic container of claim 1 wherein the container body defines a first surface texture and the handle member defines a second surface texture, the first surface texture and the second surface texture being different.

8. The blow-molded plastic container of claim 7 wherein the second surface texture is disposed on a contact surface of the handle member, the contact surface of the handle member contacting the container body.

9. The blow-molded plastic container of claim 1 wherein the handle member comprises a base plate, the adhesive being disposed between the base plate and the container body.

10. The blow-molded plastic container of claim 1 wherein the handle member is generally aligned with a longitudinal axis of the container body.

11. The blow-molded plastic container of claim 1 wherein the handle member is generally disposed at an angle relative to a longitudinal axis of the container body.

12. The blow-molded plastic container of claim 1 wherein the handle member is further mechanically coupled to the container body.

13. The blow-molded plastic container of claim 1 wherein one of the handle member and the container body having a boss portion and the other of the handle member and the container body have a debossed portion sized to mechanically couple with the boss portion.

14. The blow-molded plastic container of claim 1 wherein the handle member is a unitary member.

15. The blow-molded plastic container of claim 1 wherein the handle member is a multi-piece member.

16. A method of manufacturing a container, the method comprising:
blow molding a container body;
attaching a handle member to the blow molded container body using an adhesive; and
activating the adhesive using radiation energy.

17. The method according to claim 16, further comprising:
engaging a feature formed on the handle member to a corresponding feature formed on the container body prior to the attaching the handle member to the blow molded container body using an adhesive.

18. The method according to claim 16 wherein the activating the adhesive using radiation energy comprises activating the adhesive using ultraviolet light, visible light, and electron beam.

19. The method according to claim 16, further comprising:
manufacturing the handle member using a dual shot system.

20. The method according to claim 16, further comprising:
manufacturing the handle member using a multilayer molding system.

21. The method according to claim 16, further comprising:
manufacturing the handle member using a gas assist injection molding process.

22. The method according to claim 16, further comprising:
manufacturing the handle member using a material foaming injection molding process.
